(19) United States
(12) Patent Application Publication
(10) Pub. No.: US 2015/0228221 A1
(43) Pub. Date: Aug. 13, 2015

(54) Method and Device for Verifying a Display of Images on an Electronic Screen

(71) Applicant: JCDecaux SA, Neuilly Sur Seine (FR)

(72) Inventors: Arnaud Simon, Guyancourt (FR); Hang Ung, Paris (FR)

(21) Appl. No.: 14/618,754

(22) Filed: Feb. 10, 2015

(30) Foreign Application Priority Data
Feb. 10, 2014 (FR) 14 51004

(51) Int. Cl. G09G 3/32

(52) U.S. Cl. CPC G09G 3/32; G09G 2330/021

(57) ABSTRACT

Method for verifying a display of images on an electronic screen, comprising the following steps: displaying one image on the electronic screen; measuring one value of a display parameter during the display of the image; comparing the measured value of the display parameter with one reference value corresponding to one reference image; and if the measured value corresponds to the reference value, determining that the displayed image corresponds to the reference image. An electronic screen based on light-emitting diodes is used, and a power consumption of a portion of the electronic screen is used as the display parameter.

### FIELD OF THE INVENTION

The present invention relates to methods and devices for verifying a display of images on electronic screens based on light-emitting diodes (hereinafter LED displays).

### BACKGROUND OF THE INVENTION

A method is known, from document US 2011/0096246 A1, for verifying a display on an electronic screen, in which an optical sensor is used for capturing at least a portion of the display on the electronic screen in order to verify that the electronic screen has indeed displayed the desired images. Such a method can be used, for example, to guarantee for an advertiser that certain advertising (images or video) was indeed shown at the times desired or for the desired duration.

However, the disadvantage of this known method is that an optical sensor must be installed in front of the electronic screen, which adds to the cost and the complexity of installation.

### OBJECTS OF THE INVENTION

The present invention is intended to overcome this disadvantage.

To this end, the invention relates to a method for verifying a display of images on an electronic screen, comprising the following steps:

c) displaying at least one image on the electronic screen;

d) measuring at least one value of a display parameter during the display of said at least one image;

e) comparing said at least one measured value of said display parameter with at least one reference value corresponding to at least one reference image; and

f) if said at least one measured value corresponds to said at least one reference value, determining that said at least one displayed image corresponds to said at least one reference image,

characterized in that an electronic screen based on light-emitting diodes is used,

and in that said display parameter used is a power consumption of at least a portion of the electronic screen.

With these arrangements, it is possible to correlate a power consumption of the LED screen with a predetermined image and thereby prove that this image has indeed been displayed on the LED screen.

In various embodiments of the method according to the invention, one or more of the following arrangements may advantageously be used:
the method further comprises a prior step b) of calculating said at least one reference value corresponding to said at least one reference image;
the method further comprises a step a) of calibrating the electronic screen;
the electronic screen comprises an array of M×N pixels, each pixel having a red LED, a green LED, and a blue LED, and the step a) of calibrating the electronic screen comprises the following substeps:

a1) determining a power consumption of said at least a portion of the electronic screen when only all the red LEDs are on at maximum brightness and a maximum RGB color level;

a2) determining a power consumption of said at least a portion of the electronic screen when only all the green LEDs are on at maximum brightness and a maximum RGB color level;

a3) determining a power consumption of said at least a portion of the electronic screen when only all the blue LEDs are on at maximum brightness and a maximum RGB color level; and

a4) determining a power consumption of said at least a portion of the electronic screen when all the LEDs are off;
substeps a1) to a4) are carried out by measuring power consumptions; and
a plurality of reference images are used, each corresponding to a reference value, said plurality of reference images forming a reference video and said reference values forming a reference power consumption curve, corresponding to said reference video, for said at least a portion of the electronic screen.

The invention also relates to a device for verifying a display of images, comprising:
an electronic screen;
a central processing unit adapted to control the electronic screen and to display at least one image on the electronic screen; and
a sensor adapted to measure a display parameter during the display of said at least one image,

the central processing unit being adapted for:
receiving from said sensor at least one measured value of said display parameter;
comparing said at least one measured value of said display parameter with at least one reference value corresponding to at least one reference image; and
if said at least one measured value corresponds to said at least one reference value, determining that said at least one displayed image corresponds to said at least one reference image,

characterized in that the electronic screen is a screen based on light-emitting diodes,

and in that said display parameter is a power consumption of at least a portion of the electronic screen.

In various embodiments of the device according to the invention, one or more of the following arrangements may advantageously be used:
the central processing unit is adapted to calculate said at least one reference value corresponding to said at least one reference image; and
said sensor has a sampling frequency of 60 Hz.

### BRIEF DESCRIPTION OF DRAWINGS

The invention will be better understood on reading the following description of one of its embodiments, given only by way of non-limiting example and with reference to the accompanying drawings, in which:

FIG. 1 is a block diagram of a device according to the invention for verifying a display of images on an LED screen;

FIG. 2 is a flowchart of a method according to the invention for verifying a display of images on an LED screen; and

FIG. 3 is a front view of an LED screen displaying a given image.

### MORE DETAILED DESCRIPTION

In the various figures, the same references are used to denote identical or similar elements.

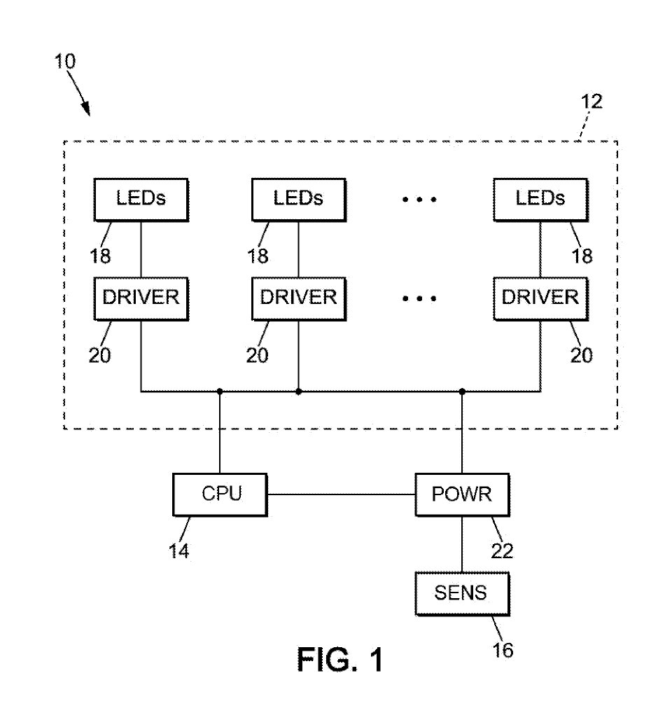

FIG. 1 illustrates a device 10 for verifying a display of images on an LED display, according to the invention.

The device 10 comprises an LED screen 12, a central processing unit 14 (CPU) adapted to control the LED screen 12 and to display at least one image on the LED screen, preferably multiple images, and a sensor 16 (SENS) suitable for measuring a display parameter during display of the images.

The display parameter used is a power consumption of at least a portion of the LED screen 12, preferably of the entire LED screen 12.

The LED screen 12 comprises an array of M×N pixels, each pixel comprising a red LED, a green LED, and a blue LED.

The LEDs are mounted on circuit boards 18 arranged adjacent to one another on a common frame.

The present invention applies both to LED screens using DIP (Dual In Place) technology in which each LED corresponds to one color (red, green, or blue) and the LEDs are through-hole mounted within the circuit boards, as well as to LED screens using SMD (Surface Mount Device) technology in which each LED corresponds to three colors (red, green, and blue) and the LEDs are surface-mounted on the boards.

Regardless of the LED technology, the electric currents required to respectively display red, green, and blue are independent from each other.

The LEDs are controlled individually by control cards 20 (DRIVER) which each control a group of LEDs, for example eight LEDs.

Each control card 20 may control some or all of the LEDs of a circuit board 18.

Advantageously, the control cards 20 control the LEDs through multiplexing, each channel of each control card 20 controlling several LEDs to cause them to operate in alternation.

The control cards 20 are controlled by the central processing unit 14, for example a microprocessor or microcontroller or similar.

The control cards 20 deliver, to each LED they control, a precisely determined electric current according to commands received from the central processing unit 14.

The device 10 further comprises a power supply module 22 (POWR) that powers the LED display 12 and the central processing unit 14.

The sensor 16 is connected to the power supply module 22 and measures the actual instantaneous power consumption of at least a portion of the LED screen 12, preferably of the entire LED screen 12.

Advantageously, the sensor 16 has a sampling frequency of 60 Hz. Such a sensor would provide reliable measurements and would be adaptable to both the European system where the PAL standard requires 25 frames per second for televisions, and the American and Japanese systems where the NTSC standard requires 30 frames per second.

The sensor 16 is, for example, a wattmeter or an ammeter.

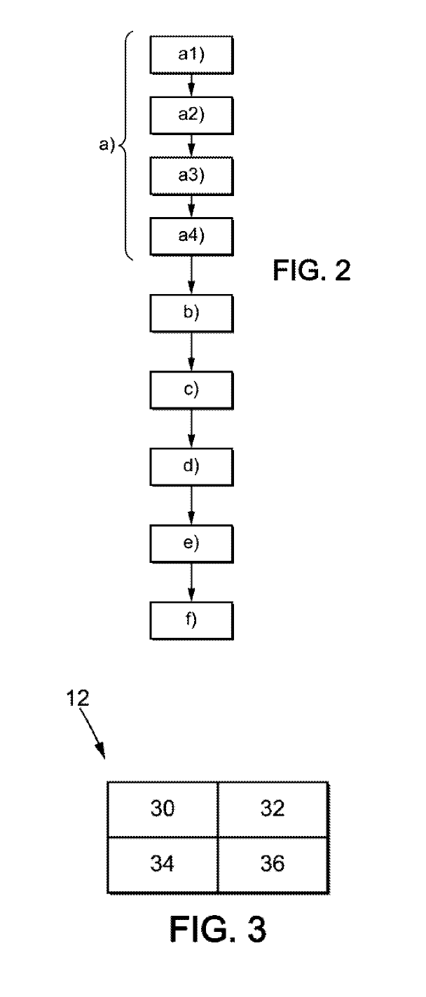

FIG. 2 illustrates the various steps of a method according to the invention for verifying a display of images on an LED screen, for example the LED screen 12 of FIG. 1.

The method is described below using an example in which the LED screen 12 is an SMD screen and comprises 128×96 pixels, each pixel being an 8-bit pixel corresponding to 256 RGB color levels ranging from 0 to 255. In addition, in this example, the determined power consumptions are those of the entire LED screen.

The method comprises a step a) of calibrating the LED screen 12, comprising the following substeps:

a1) determining a power consumption ConsoMax(R) of the LED screen 12 when only all the red LEDs are on at maximum brightness and a maximum RGB color level;

a2) determining a power consumption ConsoMax(G) of the LED screen 12 when only all the green LEDs are on at maximum brightness and a maximum RGB color level;

a3) determining a power consumption ConsoMax(B) of the LED screen 12 when only all the blue LEDs are on at maximum brightness and a maximum RGB color level; and

a4) determining a power consumption ConsoStatic of the LED screen 12 when all the LEDs are off.

Thus, in substep a1), respectively a2) and a3), the 128×96 red LEDs, respectively green and blue LEDs, are on with a brightness of 100% and an RGB color level of 255, while all green and blue LEDs, respectively red and blue LEDs, and red and green LEDs, are off.

The power consumption of the LED screen determined in substep a4), in other words when no LEDs are on (black screen) is called “static consumption.” It corresponds to the power consumption of all components of the LED screen 12 other than the LEDs, such as the central processing unit 14, the control cards 20, fans, etc.

Substeps a1) to a4) are preferably carried out by measuring power consumptions, meaning manually measuring the different power consumption values on site using the sensor 16.

Alternatively, substeps a1) to a4) may be provided by the manufacturer of the LED screen 12.

### Example

ConsoMax(R)=157 W
ConsoMax(G)=112 W
ConsoMax(B)=134 W
ConsoStatic=22.7 W

Each image corresponds to a predetermined composition of colors. Known image processing software such as Photoshop® allow obtaining the exact composition of an image in terms of RGB color level.

The principle of the invention is to associate an image with a power consumption signature that can be calculated from the colors that compose each image, and in particular from the determinations made in substeps a1) to a4).

The method therefore comprises a prior step b) of calculating power consumption reference values corresponding to reference images. This step can be implemented by the central processing unit 14.

From the ConsoMax(R,G,B) determined in substeps a1) to a3), the ConsoStatic determined in substep a4), and a characteristic of the LED screen 12 known as “Gamma”, it is possible to calculate the power consumption of the LED screen 12 for any RGB color level by using the following formula:

Conso(R,G,B)=(ConsoMax(R,G,B)−ConsoStatic)×((Value(R,G,B)/255)̂Gamma)+ConsoStatic

The gamma of a screen characterizes the contrast rendering of the screen and describes the relationship between the amplitude of the screen input signal and the luminance produced by the screen, this relationship being a power law relationship.

The gamma of a display is manufacturer data and is usually equal to 2.2 for an electronic screen.

From only four initial measurement points it is thus possible to calculate the power consumption of an LED screen displaying an all red, all green, or all blue image with a brightness of 100% for any RGB color level, and all the LEDs having the same RGB color level.

Continuation of the Example

| | Calculated power consumption (W) | | | |
|---|---|---|---|---|
| RGB level | Red R | Green G | Blue B | White W |
| 255.0 | 157.0 | 112.0 | 134.0 | 357.0 |
| 240.0 | 140.2 | 100.8 | 120.1 | 315.3 |
| 225.0 | 124.7 | 90.5 | 107.2 | 276.5 |
| 210.0 | 110.3 | 81.0 | 95.3 | 240.8 |
| 195.0 | 97.1 | 72.2 | 84.4 | 208.0 |
| 180.0 | 85.1 | 64.2 | 74.4 | 178.1 |
| 165.0 | 74.2 | 57.0 | 65.4 | 151.0 |
| 150.0 | 64.5 | 50.5 | 57.3 | 126.7 |
| 135.0 | 55.8 | 44.7 | 50.2 | 105.2 |
| 120.0 | 48.3 | 39.7 | 43.9 | 86.4 |
| 105.0 | 41.8 | 35.4 | 38.5 | 70.2 |
| 90.0 | 36.3 | 31.7 | 34.0 | 56.5 |
| 75.0 | 31.8 | 28.7 | 30.2 | 45.3 |
| 60.0 | 28.3 | 26.4 | 27.3 | 36.6 |
| 45.0 | 25.7 | 24.7 | 25.2 | 30.1 |
| 30.0 | 23.9 | 23.5 | 23.7 | 25.7 |
| 15.0 | 23.0 | 22.9 | 22.9 | 23.4 |
| 0.0 | 22.7 | 22.7 | 22.7 | 22.7 |

The white color W is obtained with a red LED, a green LED, and a blue LED, the three LEDs having the same RGB color level, which gives us:

Conso(W)=Conso(R)+Conso(G)+Conso(B)−2*ConsoStatic

It is therefore possible to accurately calculate the power consumption of a red, green, or blue LED for any RGB level by dividing the corresponding consumption by the number of LEDs in the LED screen 12.

Thus, from only four initial measurement points, it is possible to calculate the power consumption of any image.

Continuation of the Example FIG. 3 shows the LED display 12 displaying an image comprising four regions 30, 32, 34, and 36 with a brightness of 100%.

The LED screen 12 has a total of 128×96=12288 pixels.

The four regions 30-36 each occupy a quarter of the screen and therefore each contain 12288/4=3072 pixels.

Using Photoshop® or other image processing software, the color composition of each region is obtained:
region 30 (red): R=150, G=0, B=0
region 32 (green): R=0, G=50, B=0
region 34 (blue): R=0, G=0, B=230
region 36 (orange): R=220, G=132, B=25

We therefore have:
Conso(¼ red)=(157−22.7)×((150/255)̂2.2)×3072/12288=10.4478 W
Conso(¼ green)=(112−22.7)×((50/255)̂2.2)×3072/12288=0.6196 W
Conso(¼ blue)=(134−22.7)×((230/255)̂2.2)×3072/12288=22.1742 W
Conso(¼ orange)=(157−22.7)×((220/255)̂2.2)×3072/12288+(112−22.7)×((132/255)̂2.2)×3072/12288+(134-22.7)×((25/255)̂2.2)×3072/12288=24.2637+5.2440+0.1681=29.6758 W

The total calculated power consumption of the LED screen 12 is therefore:
ConsoTot=Conso(¼ red)+Conso(¼ green)+Conso(¼ blue)+Conso(¼ orange)+ConsoStatic=62.9175+22.7=85.6175 W.

By comparison, the total measured consumption is 85.1 W, so a calculation error of 0.6%.

Returning to FIG. 2, the method further comprises a step c) of displaying at least one image, preferably a plurality of images, on the LED screen 12. This step can be implemented by the central processing unit 14.

The method further comprises a step d) of measuring at least one value, preferably several values, of the actual instantaneous power consumption of the LED screen 12 when the images are displayed. This step is implemented using the sensor 16, by directly measuring the instantaneous electrical power consumed by the LED screen or the instantaneous electric current. The resulting data may be stored by the central processing unit 14 or may be sent by the central processing unit 14 to a memory of a remote server for later processing. In addition to the measured power consumption values, the data obtained may also include the date and time of the measurements.

The method further comprises a step e) of comparing the measured power consumption values with reference power consumption values calculated in step b). This step can be implemented by the central processing unit 14 or by the remote server if there is such.

The method further comprises a step f) wherein, if at least one of the measured values corresponds to at least one of the reference values, it is determined that the respective displayed image corresponds to the respective reference image. This step can be implemented by the central processing unit 14 or by the remote server if there is such.

In addition to this determination, the central processing unit 14 and/or the remote server are also adapted to process the data obtained, meaning to determine the date and time the image was displayed, the length of time the image was displayed, and the frequency at which the image was repeatedly displayed. In cases where there are several LED screens to verify, the remote server is also adapted to indicate on which LED screen(s) the image was broadcast.

The invention therefore makes it possible to correlate a measured power consumption of the LED screen to a given image, with relatively good accuracy, and therefore to prove that this image has indeed been displayed by the screen.

Of course, the invention also applies to a video, which can be defined as a succession of images. It is thus possible to certify the content of a display having its signature be the power consumption curve of the LED screen. Indeed, the reference power consumption values of the images composing the video form a reference power consumption curve corresponding to the video, with the power consumption of the video varying over time. By comparing this calculated reference curve to the measured consumption curves, it is possible where applicable to confirm that the video was actually displayed on the LED screen.

It should be noted that the power consumption of the LED screen is linear with the screen brightness. Thus, if the LED screen is adjusted to another brightness level, it is sufficient to apply a correction factor to the measured power consumptions.

More generally, it is possible to perform the comparison effectively regardless of differences in the LED screen settings by using a correlation between the reference signature and the measured signature, for example by pattern recognition.

In all of the above description, the calculations/measurements were made for the entire LED screen 12, but it is quite possible to apply the invention to only a part of the screen, for example performing the calculations/measurements only on the LEDs of certain circuit boards 18.

It is also possible to provide a plurality of sensors 16, each dedicated to a predetermined portion of the LED screen. In particular, with a sensor for the left half of the screen and another sensor for the right portion of the screen, this would avoid cases where the image is displayed in reverse, because in such cases the power consumption associated with the image is the same as that associated with the unreversed image.

The invention therefore proposes a method and a device for associating a power consumption signature with a given image and recording this signature using a power consumption sensor installed upstream of an LED screen, thereby providing tangible evidence providing very reliable proof that the image or video content has actually been displayed.

1. A method for verifying a display of images on an electronic screen, comprising the following steps:
displaying at least one image on the electronic screen;
measuring at least one value of a display parameter during the display of said at least one image;
comparing said at least one measured value of said display parameter with at least one reference value corresponding to at least one reference image; and
if said at least one measured value corresponds to said at least one reference value, determining that said at least one displayed image corresponds to said at least one reference image,
wherein an electronic screen based on light-emitting diodes is used,
and wherein said display parameter used is a power consumption of at least a portion of the electronic screen.

2. The method according to claim 1, further comprising a prior step b) of calculating said at least one reference value corresponding to said at least one reference image.

3. The method according to claim 1, further comprising a step a) of calibrating the electronic screen.

4. The method according to claim 3, wherein the electronic screen comprises an array of M×N pixels, each pixel having a red LED, a green LED, and a blue LED, and the step a) of calibrating the electronic screen comprises the following substeps:
determining a power consumption of said at least a portion of the electronic screen when only all the red LEDs are on at maximum brightness and a maximum RGB color level;
determining a power consumption of said at least a portion of the electronic screen when only all the green LEDs are on at maximum brightness and a maximum RGB color level;
determining a power consumption of said at least a portion of the electronic screen when only all the blue LEDs are on at maximum brightness and a maximum RGB color level; and
determining a power consumption of said at least a portion of the electronic screen when all the LEDs are off.

5. The method according to claim 4, wherein substeps a1) to a1) are carried out by measuring power consumptions.

6. The method according to claim 1, wherein a plurality of reference images are used, each corresponding to a reference value, said plurality of reference images forming a reference video and said reference values forming a reference power consumption curve, corresponding to said reference video, for said at least a portion of the electronic screen.

7. A device for verifying a display of images, comprising:
an electronic screen;
a central processing unit adapted to control the electronic screen and to display at least one image on the electronic screen; and
a sensor adapted to measure a display parameter during the display of said at least one image,
the central processing unit being adapted for:
receiving from said sensor at least one measured value of said display parameter;
comparing said at least one measured value of said display parameter with at least one
comparing said at least one measured value of said display parameter with at least one reference value corresponding to at least one reference image; and
if said at least one measured value corresponds to said at least one reference value, determining that said at least one displayed image corresponds to said at least one reference image,
wherein the electronic screen is a screen based on light-emitting diodes,
and in that said display parameter is a power consumption of at least a portion of the electronic screen.

8. The device according to claim 7, wherein the central processing unit is adapted to calculate said at least one reference value corresponding to said at least one reference image.

9. The device according to claim 7, wherein said sensor has a sampling frequency of 60 Hz.
